(19) United States
(12) Patent Application Publication
(10) Pub. No.: US 2025/0164351 A1
(43) Pub. Date: May 22, 2025

(54) TIRE TREAD GAUGING DEVICE

(71) Applicant: ROADGUARD AS, Oslo (NO)

(72) Inventors: Christian Wilhelm STANG, Oslo (NO); Josef ELLINGSEN, Skotselv (NO)

(21) Appl. No.: 18/839,104

(22) PCT Filed: Feb. 16, 2023
(86) PCT No.: PCT/NO2023/050037

§ 371 Date: Aug. 16, 2024

(30) Foreign Application Priority Data
Feb. 18, 2022 (NO) 20220226

(51) Int. Cl. G01M 17/02; B08B 5/02

(52) U.S. Cl. CPC G01M 17/027; B08B 5/023

(57) ABSTRACT

A drive-over tire tread depth gauging system includes a housing (110) including an optical opening (120), where the housing (110) is configured to be embedded in a road (130) such that a tire (140) of a vehicle can roll across the optical opening (120) of the housing (110), an optical scanner (150) disposed inside the housing (110), where the optical scanner (150) is configured to measure, through the optical opening (120) of the housing (110), the tread depth of the tire (140) as the tire (140) rolls across the optical opening (120) of the housing (110), and at least one air nozzle (170) configured to provide an air flow barrier (180) between the optical scanner (150) and the optical opening (120) of the housing (110). A method employs the drive-over tire tread depth gauging system (100) and the use of such a system.

### FIELD OF DISCLOSURE

The disclosure relates to the field of optical systems.

### BACKGROUND

Tire treads are generally employed for improving the traction of tires with the ground, for example against wet surfaces by preventing hydroplaning. Treaded tires are particularly important in cold climates that are prone to snowfall and frost, as wide treads are commonly employed in order to give traction with snow and ice. Tire treads are unfortunately prone to wear, hence causing a reduction of traction over time, and eventually resulting in a need to replace the tire.

In order to maintain road safety, most jurisdictions have introduced requirements on tire tread depth. However, as it is generally the responsibility of the owner of the vehicle to ensure that the tread depths are within the legal limits, many vehicles may be found on the road equipped with tires that are not road legal. Increasing international travel, and varying requirements for tread depths across international border further contribute to a high number of vehicles on the road without road legal tires. The latter being a particular problem when freight is transported by road into a country with icy conditions from a country with a warm and generally frost free climate.

In order to improve road safety, various national authorities have recently started showing interest in installing automatic drive-over tire thread dept gauging sensors in the road that are configured to measure the tire thread depth of cars as these drive across the sensor. Several drive-over tire thread depth gauging sensors are already know in the art, but these have until now largely been employed inside, for example in garages and workshops.

A problem with existing drive-over tire thread dept gauging sensors is namely that the optics of the sensors over time get polluted by environmental debris like dust, gravel, dirt etc., hence causing a reduction of the accuracy of the sensors. Various solutions have been implemented in order to deal with the latter issue, including the employment of built in cleaning systems, for example based on the provision of a cleaning fluid or the employment of air blasts for cleaning optical surfaces.

U.S. Pat. No. 9,046,446 describes an example of a drive-over optical tire tread depth sensor with a build in self-cleaning system. The drive-over optical tire tread depth sensor of U.S. Pat. No. 9,046,446 comprises an optical component placed beneath a vehicle support surface through which the optical component is configured to measure a tire as the latter rolls over the vehicle support surface. An air nozzle is provided in order to periodically blast-clean the vehicle support surface as debris accumulate on said surface over time. A problem with the solution in U.S. Pat. No. 9,046,446, however, is that debris is in fact freely allowed to gather on the vehicle support surface. The vehicle support surface is therefore prone to wear over time, especially if the drive-over optical tire tread depth sensor is employed in the road for a prolonged duration of time, or is employed in ice conditions where there is extensive debris pollution from pollutants such as road salt, dust, sand and gravel.

The present disclosure describes a drive-over tire tread depth gauging system suitable for long time employment in a road. The drive-over tire tread depth gauging system of the present disclosure is equipped with a pollution rejection mechanism based on a special arrangement of one or more air nozzles.

### SUMMARY OF THE DISCLOSURE

A first aspect of the present disclosure provides a drive-over tire tread depth gauging system, the system comprising a housing comprising an optical opening, where the housing is configured to be embedded in a road such that a tire of a vehicle can roll across the optical opening of the housing, an optical scanner arranged inside the housing, where the optical scanner is configured to measure, through the optical opening of the housing, the tread depth of the tire as the tire rolls across the optical opening of the housing, a housing lid movable between a closed position in which the optical opening is covered by the housing lid, and an open position in which the optical opening is uncovered or partly covered by the housing lid, and at least one air nozzle configured to continuously provide an air flow barrier between the optical scanner and the optical opening of the housing whenever the housing lid is in the open position.

In an embodiment of the disclosure the at least one air nozzle is configured to provide an air flow from within the housing, out through the optical opening of the housing.

In another embodiment of the disclosure the drive-over tire tread depth gauging further comprises lower suction means for extracting any one or more of air, liquid, dust, sand, salt and gravel at least from below the air flow barrier.

In yet another embodiment of the disclosure the drive-over tire tread depth gauging further comprises upper suction means for extracting any one or more of air, liquid, dust, sand, salt and gravel at least from between the air flow barrier and the optical opening of the housing.

In yet another embodiment of the disclosure the upper suction means is arranged at least partly in a direct air flow path from the air nozzle.

In yet another embodiment of the disclosure the drive-over tire tread depth gauging further comprises a transparent wall provided between the optical scanner and the optical opening of the housing, where the at least one air nozzle is configured to continuously provide the air flow barrier between the transparent wall and the optical opening of the housing whenever the housing lid is in the open position.

In yet another embodiment of the disclosure the upper suction means is configured to extract any one or more of air, liquid, dust, sand, salt and gravel at least from between the transparent wall and the optical opening of the housing.

In yet another embodiment of the disclosure the drive-over tire tread depth gauging further comprises a liquid inlet for providing a cleaning liquid to the surface of the transparent wall facing the optical opening of the housing.

In yet another embodiment of the disclosure the drive-over tire tread depth gauging further comprises a heat source configured to heat at least a part of the drive-over tire tread depth gauging system.

In yet another embodiment of the disclosure the at least one air nozzle comprises at least one air knife.

In yet another embodiment of the disclosure the at least one air knife is a linear air knife arranged in or along at least one wall of the housing.

In yet another embodiment of the disclosure the drive-over tire tread depth gauging further comprises at least one air guide for guiding the air flow from the at least one air nozzle.

In yet another embodiment of the disclosure the optical scanner comprises a laser triangulation scanner.

A second aspect of the present disclosure provides use of a drive-over tire tread depth gauging system for measuring the tread depth of a tire of a moving vehicle, optionally inside a tunnel.

A third aspect of the present disclosure provides a method for gauging the tire tread depth of a moving vehicle, the method comprising the steps of providing a drive-over tire tread depth gauging system, embedding the drive-over tire tread depth gauging system in a road or road segment such that the top opening of the housing of the drive-over tire tread depth gauging system aligns with the surface of the road or road segment, moving the housing lid of the drive-over tire tread depth gauging system from a closed position to an open position, providing a continuous air flow barrier between the optical scanner and the optical opening of the housing as long as the housing lid is in the open position, and measuring, by the optical scanner of the drive-over tire tread depth gauging system, the tire tread depth of the tire of the moving vehicle as the vehicle drives across the drive-over tire tread depth gauging system.

### BRIEF DESCRIPTION OF THE DRAWINGS

FIG. 1 is a schematic illustration of a drive-over tire tread depth gauging system embedded in a road,

FIG. 2a is a schematic illustration of a drive-over tire tread depth gauging system comprising an air knife, and a housing lid in a closed position,

FIG. 2b is a schematic illustration of a drive-over tire tread depth gauging system comprising an air knife, and a housing lid in an open position,

FIG. 3a is a schematic illustration of a drive-over tire tread depth gauging system comprising a housing lid in a closed position,

FIG. 3b is a schematic illustration of a drive-over tire tread depth gauging system comprising a housing lid in an open position,

FIG. 4 is a schematic illustration of a drive-over tire tread depth gauging system comprising upper suction means and lower suction means,

FIG. 5 is a schematic illustration of a drive-over tire tread depth gauging system comprising a transparent wall between the optical scanner and the optical opening,

FIG. 6 is a schematic illustration of a drive-over tire tread depth gauging system comprising a liquid inlet and heating means for heating at least a part of the drive-over tire tread depth gauging system,

FIG. 7 is a schematic illustration of a drive-over tire tread depth gauging system comprising an air guide for guiding the air stream from an air nozzle of the drive-over tire tread depth gauging system, and

FIG. 8 is a schematic illustration of a drive-over tire tread depth gauging system comprising an air nozzle arranged to direct an air stream out through the optical opening of the drive-over tire tread depth gauging system.

### DETAILED DESCRIPTION OF THE DISCLOSURE

In the following, general embodiments as well as particular exemplary embodiments of the disclosure will be described. References will be made to the accompanying drawings. It shall be noted, however, that the drawings are exemplary embodiments only, and that other features and embodiments may well be within the scope of the disclosure as claimed. Further, the mentioning of references such as “a” or “an” etc. should not be construed as excluding a plurality.

Unless otherwise defined, all terms of art, notations and other scientific terms or terminology used herein are intended to have the meanings commonly understood by those of skill in the art to which this disclosure pertains. Certain terms of art, notations, and other scientific terms or terminology may, however, be defined specifically as indicated below.

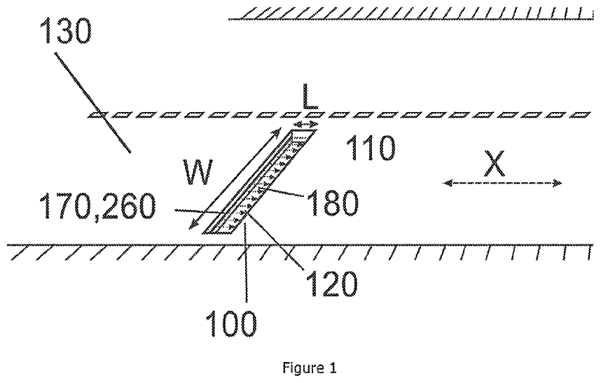

The present disclosure provides a drive-over tire tread depth gauging system 100. The drive-over tire tread depth gauging system 100 is configured to being embedded in a road 130 such that the tread depth of a tire may be measured as the vehicle equipped with said tire drives along the road 130 and across the drive-over tire tread depth gauging system 100. The drive-over tire tread depth gauging system 100 comprises a housing 110 with an optical opening 120, a housing lid for covering the optical opening 120, an optical scanner provided in the housing, and an air nozzle. FIG. 1 schematically illustrates a drive-over tire tread depth gauging system 100 embedded in a road 130. It will be appreciated that a drive-over tire tread depth gauging system 100 may generally be known in the art under different terminologies, e.g. a drive-over optical tread depth sensor, a tire tread scanner drive-over device, a tire tread scanner drive-over system or similar. The term gauge, may in the context of the present disclosure be understood as synonymous with terms such as measure or determine.

The drive-over tire tread depth gauging system 100 may, as schematically illustrated in FIGS. 1-3, be embedded in a road 130 or road segment such that a vehicle may drive across the system 100 with at least one of its wheels passing over the optical opening 120 of the housing 110. The system 100 may ideally be embedded in a road 130 or road segment such that the top of the housing 110, and consequently the optical opening 120 of the housing 110, aligns with the surface of the road 130 or road segment. The optical opening 120 may generally be considered as provided in the top wall of the housing 110, and provides a physical connection between the interior and the exterior of the housing 110. The optical scanner 150 provided in the housing 110 may then through visual communication with the tire 140 through the optical opening 120 of the housing 110 gather optical data that may directly or indirectly be used in order to deduce the thread depth of said tire 140. In order to stop any contaminant such as water, snow, dust, sand, salt, gravel and/or other types of debris from polluting optical scanner 150, the drive-over tire tread depth gauging system 100 is provided with a housing lid 160 and an air nozzle 170. When not actively performing any measurements, the housing lid 160 may be used to cover the optical opening 120 of the housing 110, hence protecting the optical scanner 150 from typical environmental pollutants such as water, dust, sand, salt, pollen, snow and gravel. Upon the approach of a vehicle, and the subsequent opening 120 of the housing lid 160, the air nozzle 170 may be activated in order to provide an air flow barrier 180 between the optical scanner 150 and the tire 140 to be analyzed. Any contaminant entering the housing 110 while the housing lid 160 is open will upon coming contact with the air flow barrier 180, be blown away, i.e. repelled, by the air flow instead of reaching and thereby polluting the optical scanner 150 and any appurtenant optics. The presence of an air flow barrier 180 therefore reduces the amount of contaminants collecting on the optical scanner 150 over time, and hence reduces the need for maintenance of the drive-over tire tread depth gauging system 100.

The housing may according to the present disclosure be any housing that is adapted to being embedded in a road or segment of a road such that a road vehicle may pass across the housing without causing any irreversible damage to the housing. The housing may for example be a casing of stainless steel, a concrete enclosure or a housing made of any other similar rigid material or combination of materials chosen in order to enable the housing to bear the weight of any type of standard road vehicle.

As will be appreciated by a person skilled in the art with knowledge of the present disclosure, the housing may generally take on a wide variety of shapes and sizes. The housing may generally be shaped such that it comprises a housing interior with a shape and size suitable for accommodating the optical scanner and optionally the air nozzle. The housing may additionally be shaped and dimensioned such that the housing interior may accommodate additional equipment, such as for example communication equipment, and/or other auxiliary equipment. Communication equipment may for example comprise a transmitter and/or a sender configured to communicate data to and/or from the optical scanner from some remote source. Examples of auxiliary equipment may for example comprise one or more of a power source, control unit, a data processing device.

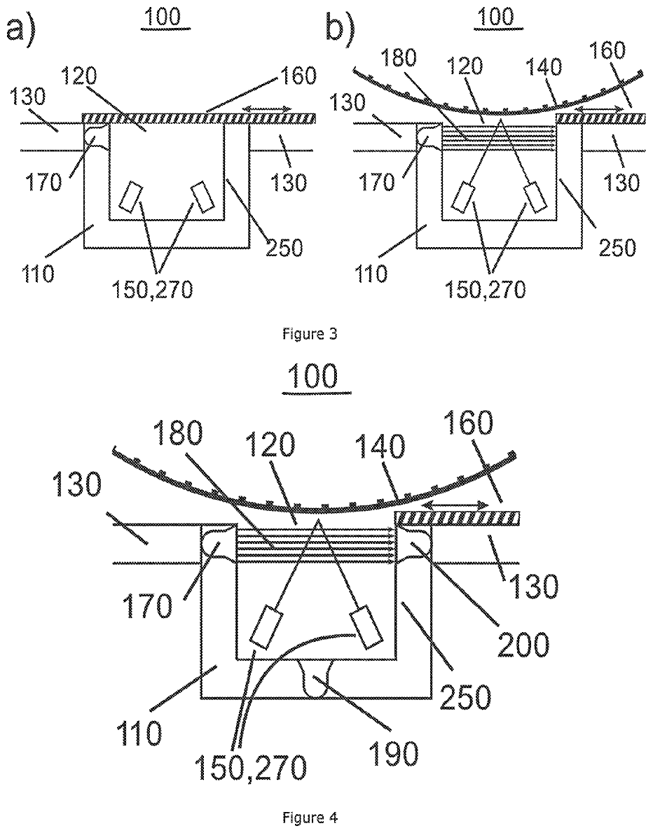

As schematically illustrated in FIGS. 1, 3a and 3b, the housing 110 is adapted to being embedded in a road 130 or road segment. Being embedded in a road 130 or road segment may here be understood as being built in as a part of the road 130 or road segment such that vehicles driving along the road 130 may drive across the housing 110 with one or more of their wheels passing directly over the housing 110. The system 100 may ideally be embedded in a road 130 or road segment such that the top of the housing 110, and consequently the optical opening 120 of the housing, aligns with the surface of the road 130 or road segment. Said alignment will result in a plane road surface, without the drive-over tire tread depth gauging system 100 creating any protruding bump in the road 130. As will be appreciated by a person skilled in the art with knowledge of the present disclosure, the exact way in which the housing 110 may be embedded may vary. The embedment may for example be provided though employment of expansion compensating mechanical joints that compensates for any thermal expansion mismatch between the road 130 and the optical housing 110. Alternatively, the embedment may be provided by simply placing and securing the housing 110 in a predesigned slot in the road 130 or road segment.

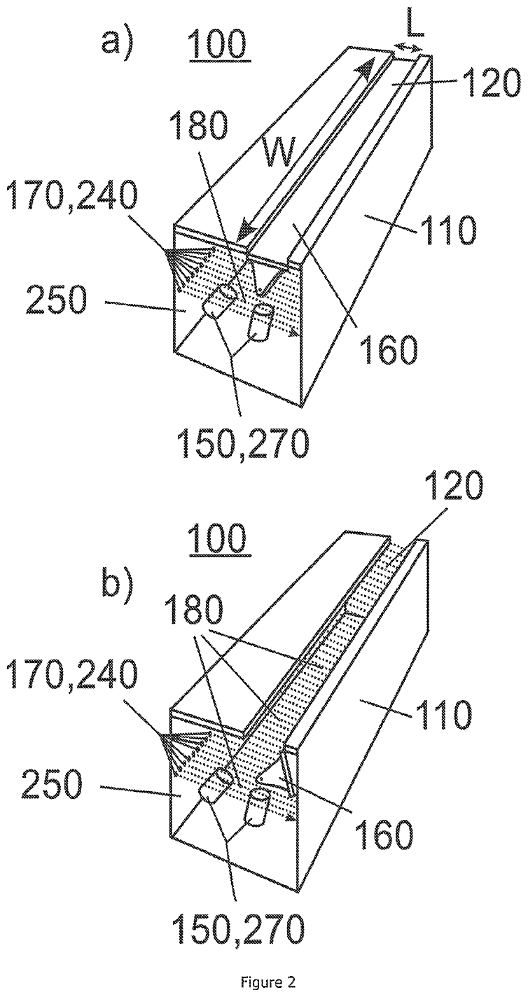

As schematically illustrated in FIGS. 3a and 3b, the housing 110 is provided with an optical opening 120. The optical opening 120 is generally positioned on the housing 110 such that the optical opening 120 may provide a visual transmission between the interior of the housing 110 and the exterior top side of the housing 110 when the housing 110 is embedded in a road 130 or road segment. The exact size, shape and orientation of the optical opening 120 may vary, but are generally chosen such that the optical scanner 150 provided inside the housing 110 may obtain visual connection with a tire positioned over the optical opening 120. The optical opening 120 may be a physical opening between the interior and exterior of the housing 110, optionally with a size, shape and orientation that may be chosen in order to minimize the impact on a vehicle driving across the drive-over tire tread depth gauging system 100. A too large optical opening 120 may for example cause a tire 140 to be measured to fall a significant distance into the optical opening 120 as the vehicle with the tire 140 drives across the drive-over tire tread depth gauging system 100. On the contrary, a too small optical opening 120 may cause difficulties in obtaining a clear line of sight between the optical scanner 150 and the tire 140 to be measured. As schematically illustrated in FIGS. 2a and 2b, the shape of the optical opening 120 may be influenced by the thickness of any top wall of the housing 110 in which the optical opening 120 is provided.

FIGS. 1, 2a and 2b schematically illustrate an example of a 110 housing provided with an optical opening 120. The optical opening 120 is here illustrated with a length, L, and width, W, being perpendicular to one another, where the length of the optical opening 120 being illustrated as being parallel with the driving direction, X, of a road 130 or road segment in which the housing 110 is embedded. A length in the range from 5 cm to 10 cm has generally been found to be preferred, as such a width has been found to enable adequate line of sight between the optical scanner 150 while enabling most standard road tires to pass without causing an unacceptable obstacle to the vehicle carrying the tire. The housing 110 may, as schematically illustrated in FIGS. 1, 2a and 2b, generally be provided with an optical opening 120 with a rectangular shape such that the width of the optical opening 120 is larger than the length. A width larger than 50 cm has generally been found to be preferred in order ensure that a vehicle passing the drive-over tire tread depth gauging system 100 will actually have one of its tires pass over the optical opening 120 of the drive-over tire tread depth gauging system 100. In a preferred embodiment of the disclosure the optical opening 120 is shaped as a slit with a width>length.

FIGS. 2a, 2b, 3a and 3b schematically illustrate a drive-over tire tread depth gauging system 100 comprising a housing lid 160. The hosing lid 160 is moveable between a closed position in which the optical opening 120 is covered by the housing lid 160, and an open position in which the optical opening 120 is uncovered or partly covered by the housing lid 160. As will be appreciated by a person skilled in the art with knowledge of the present disclosure, the housing lid 160 may take on a variety of shapes, and the housing lid 160 may thus alternatively be termed a cover, shutter, cap or top. The housing lid 160 may for example be a flap, a slidable plate, or a foldable shutter. FIGS. 2a and 2b schematically illustrate an embodiment of the disclosure where the housing lid is a rotatable shutter. The rotatable shutter may, based on its rotational orientation, be in an open or closed position. In FIG. 2a the housing lid 160 is shown in a closed position, while in FIG. 2b the housing lid 160 is shown in an open position.

As will be appreciated by a person skilled in the art with knowledge of the present disclosure, the housing lid may generally be moved between the closed and open position by employment of suitable moving means. The housing lid may for example be moved between the closed and open position by employment of an actuator such as an electrical motor or an electromagnet. The moving means, such as an actuator, may further be controlled using a suitable control unit. The latter may for example be an on-site or remote computer. In a particular embodiment of the disclosure, the housing lid may be moved between the closed and open position as a response to the detection of an approaching vehicle. An approaching vehicle may for example be detected using a camera next to the road, which may communicate a signal to the moving means, asking for the housing lid to be opened. In another embodiment of the disclosure, the lid may be kept open between measurements. For example on a highway, a opening and closing cycle of the lid may depend on not only approaching cars, but also weather conditions and the speed/sequence approaching cars. It will be appreciated by a person skilled in the art with knowledge of the present disclosure that the duration of the opening of the lid may vary significantly beyond the passing of a single car.

The drive-over tire tread depth gauging system 100 comprises according to the present disclosure an optical scanner 150 arranged inside the housing 110. The optical scanner 150 is configured to measure, through the optical opening 120 of the housing 110, the tread depth of the tire 140 as the tire 140 rolls across the optical opening 120 of the housing 110. The optical scanner 150 may thus be arranged inside the housing 110 with a line of sight to the optical opening 120 of the housing 110. When a tire 140 is located by the optical opening 120, the optical scanner 150 may then capture an image of the tire 140 that further may be analysed in order to determine the tread depth of the tire 140. The FIGS. 2-8 schematically illustrate the optical scanner 150 as a combination of two units, for example being a light source and a detector. It will, however, be appreciated that the optical scanner 150 may be provided in a single physical casing. The two illustrated units may for example constitute a laser triangulation scanner 270, with one unit illustrating a laser and the other unit illustrating a detector or camera.

The optical scanner may generally be considered to include all the means needed in order to measure the tread depth of the tire as the tire roles across the optical opening. The optical scanner may therefore comprise the optical equipment required in order to capture an image of a tire, including at least a camera, and optionally one or more of a lens or lenses, light source, reflectors, etc. The optical scanner may optionally comprise image processing means configured to analyse said image in order to determine the tread depth from the image. Image processing means may for example be a computer, located locally or remotely. The capture of an image of a tire that may subsequently be used in order to determine the tread depth of the tire may in the context of the present disclosure be considered as a measurement of the tread depth of the tire. As will be appreciated by a person skilled in the art, optical scanners suitable for measuring the tread depth of the tire are well known in the art.

In a particular embodiment of the present disclosure the optical scanner comprises a laser triangulation scanner. The laser triangulation scanner comprises at least a detector, e.g. a camera, and a laser, preferably a line laser. The laser triangulation scanner may generally have a standard geometry with relationship to the optical opening of the housing, i.e. that the laser has a normal incidence with the optical opening of the housing, and that the laser has an inclined incidence. The laser triangulation scanner may alternatively have a reverse alignment, i.e. where the laser and the detector have swapped position relative to the standard geometry. The laser triangulation scanner may alternatively have a specular geometry, or a look-away geometry. A reverse geometry may be preferred in order to achieve a high hight resolution image, while a look away geometry may be preferred in order to obtain high resolution with reflective surfaces, e.g. during wet or icy conditions when the tires are more reflective than normal. A specular geometry may be preferred if the surface of the tire is very dark, e.g. when a measurement is performed during night or winter.

The drive-over tire tread depth gauging system 100 comprises, as schematically illustrated in FIGS. 1-8, at least one air nozzle 170 configured to continuously provide an air flow barrier 180 between the optical scanner 150 and the optical opening 120 of the housing 110. An air flow barrier 180 may generally in the context of the present disclosure be interpreted as a volume of continuous air flow that separates two other volumes. More precisely, the air flow barrier 180 according to the present disclosure may be interpreted as a volume of continuous air flow that separates the optical scanner 150 from the optical opening 120 of the housing 110. Any object, particle or water droplet entering the housing 110 through the optical opening 120 of the housing 110 will thus not be able to reach the optical scanner 150 by any path that would not pass through said volume of continuous air flow. Thus by providing a sufficiently strong air flow, said volume of continuous air flow will act as a barrier 180 for any object, particle or water droplet entering the housing 110 through the optical opening 120, as any such object, particle, water droplet or other type of pollutant mentioned herein may be blown away, i.e. repelled, by the air flow of the air flow barrier 180 before reaching the optical scanner 150. It will be appreciated by a person skilled in the art that the exact shape and strength of the air flow needed in order to provide an air flow barrier 180 will depend on the size and shape of the housing 110, and on the requirements for rejection of foreign contaminants. The drive-over tire tread depth gauging system may generally comprise any number of air nozzles 170, for example one air nozzle 170 or two air nozzles 170. Any air nozzle 170 may according to any embodiment of the present disclosure be an air knife 240.

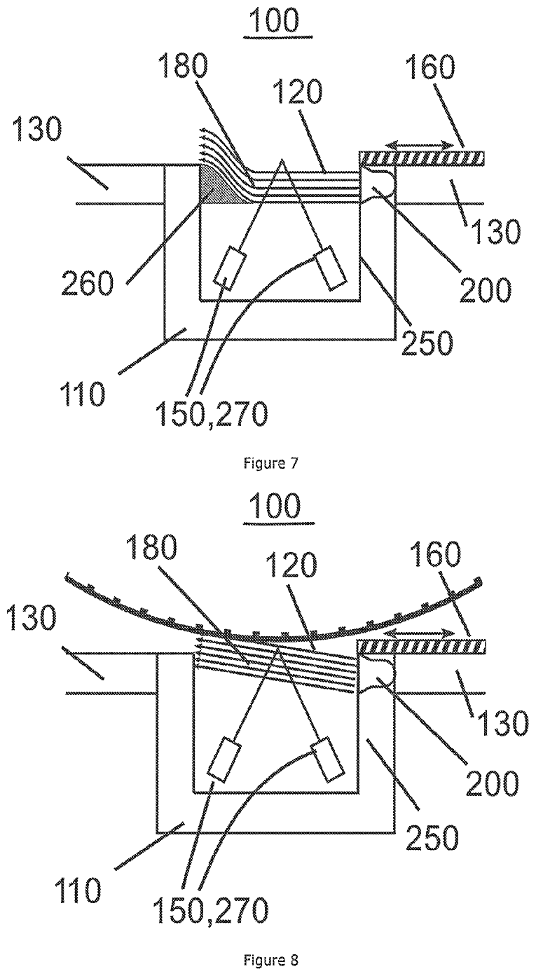

The drive-over tire tread gauging system 100 may generally comprise one or more air guides 260 for guiding the air flow from the at least one air nozzle 170. The air guides 260 may thus be used in order to shape the air flow barrier 180 as desired, for example by concentrating the air flow into a volume adjacent to the optical opening 120. FIG. 7 schematically illustrates drive-over tire tread gauging system 100 comprising an air guide 260 for guiding the air flow from the at least one air nozzle 170 out of the housing 110.

FIGS. 1, 2a and 2b schematically illustrate a drive-over tire tread depth gauging system 100 that comprises an air knife 240. The drive-over tire tread depth gauging system 100 may generally comprise one or more air knives 240. An air knife 240 may in the context of the present disclosure be considered as an air nozzle 170 configured to provide a laminar air flow. An air knife 240 may for example be an elongated air knife 240 configured to provide an approximately plane laminar air flow. A plane laminar air flow is particularly suitable for providing an air flow barrier 180 between the optical scanner 150 and the optical opening 120 of the housing 110. A plane laminar air flow is preferred as it allows for similar air flow conditions across the air flow barrier 180. An elongated air knife 240 may generally be known as a linear air knife. FIGS. 1, 2a, and 2b schematically illustrate a particular embodiment of the disclosure where the drive-over tire tread depth gauging system 100 comprises at least one linear air knife 240 arranged in or along at least one wall 250 of the housing 110. Such an arrangement has been found to enable a relatively homogeneous and continuous air flow barrier 180 between the optical opening 120 of the housing 110 and the optical scanner 150.

FIG. 8 schematically illustrates an embodiment of the disclosure where the drive-over tire tread depth gauging system 100 comprises at least one air nozzle 170 that configured to provide an air flow from within the housing 110, out through the optical opening 120 of the housing 110. As will be appreciated by a person skilled in the art with knowledge of the present disclosure an air nozzle 170 may be configured to provide an air flow from within the housing 110, out through the optical opening 120 of the housing by arranging said air nozzle 170 within the housing 110 such that it faces the optical opening 120 of the housing 110. A configuration where the air flow from the an air nozzle 170 is directed out through the optical opening 120 of the housing is preferable as any debris coming into contact with the air flow will be blown out of the housing 110 instead of being allowed to contaminate the optical scanner 150 or accumulate inside the housing 110.

The housing lid may generally be used to protect the optical scanner when the drive-over tire tread depth gauging system is turned off or idle. The housing lid may thus generally be employed in order to protect the the optical scanner from environmental pollutants such as water, dust, sand, salt, pollen, snow and gravel. During a measurement, however, the lid needs to be in the open position in order to enable visual communication between the optical scanner and the tire to be measured, thereby no longer offering protection of the optical scanner from pollutants. As a way of maintaining a continuous protection of the optical scanner from pollutants, the at least one air nozzle of the drive-over tire tread depth gauging system is configured to continuously provide an air flow barrier between the optical scanner and the optical opening of the housing whenever the housing lid is in an open position. The air nozzle is thus used both to protect the optical scanner from both environmental pollutants, and also from pollutants introduced by the tire itself. The air nozzle may therefore be activated as a response to the opening of the housing lid. As previously described the housing lid is in an open position when the housing lid is not covering or only partly covering the optical opening of the housing. It will be appreciated by a person skilled in the art that the mechanism controlling the activation of the air nozzle may be realized in a series of ways. The housing lid and the air nozzle may for example both be connected to a control unit that is configured to control the activation and deactivation of the air nozzle based on the position of the housing lid.

FIGS. 4-6 schematically illustrate a drive-over tire tread depth gauging system 100 further comprising lower suction means 190 located in the housing 110 below the air flow barrier 180. The lower suction means 190 may generally be any type of means configured to create an under-pressure, e.g. a pump, compressor, fan or similar. The lower suction means 190 may generally be employed in order to extract any pollutants that may traverse the air flow barrier 180 and consequently being trapped below the air flow barrier 180. Examples of such pollutants may for example be larger particles such as gravel that are too heavy for the air flow barrier 180 to repel, or alternatively be dust, sand, salt, water or other pollutants that may traverse the air flow barrier 180. As it will be appreciated that a perfect air flow barrier 180 may be hard to realize for all types of pollutants, the lower suction means 190 may be employed in order to compensate for any imperfection of the air flow barrier 180. The lower suction means 190 may thus in the context of the present disclosure be configured to extract any one or more of air, liquid, dust, sand, salt and gravel at least from below the air flow barrier 180. The liquid may generally for example be water, cleaning fluid, or other types of liquid.

In addition to or as an alternative to comprising lower suction means 190, the drive-over tire tread depth gauging system 100 may, as schematically illustrated in FIGS. 4-6, comprise upper suction means 200 for extracting any one or more of air, liquid, dust, sand, salt and gravel at least from between the air flow barrier 180 and the optical opening 120 of the housing 110. The upper suctions means 200 may generally be any types of means configured to create an under pressure, e.g. a pump, compressor, fan or similar. The upper suction means 200 may generally be employed in order to extract pollutants that are present above the air flow barrier 180 and/or any pollutants that may reach the air flow barrier 180 and consequently be repelled by the air flow barrier 180. The upper suction means 200 may thus soak up the air flow in the air flow barrier 180, hence optimally balance an even pressure in the housing 110. The upper suction means 200 may for example be configured such that a fixed over pressure is created inside the housing 110 relative to the exterior of the housing 110. In a particular embodiment of the present disclosure, the upper suction means 200 may be arranged at least partly in a direct air flow path from the air nozzle 170. The latter arrangement may be preferred if it is desired to minimize turbulence above the air flow barrier 180. Low turbulence above the air flow barrier 180 improves on the optical conditions for the optical scanner 150, as turbulent flow may cause disturbances in the optical path of the optical scanner 150.

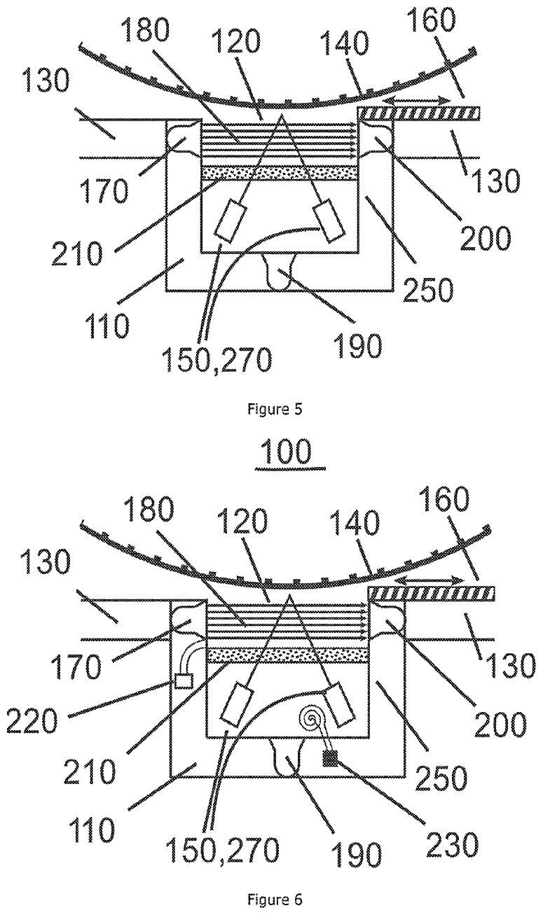

In order to isolate the optical scanner 150 from the exterior of the housing 110 the drive-over tire tread depth gauging system 100 may further comprise a transparent wall 210 arranged between the optical scanner 150 and the optical opening 120 of the housing 110. The employment of a transparent wall 210 may be preferred in order to reduce the need for maintenance of the optical scanner 150, for example because the employment of a transparent wall 210 contributes to keeping moisture and other previously mentioned pollutants away from the optical scanner 150. Moisture in particular may cause corrosion of key elements of the optical scanner 150, hence eventually leading to a need for performing maintenance. When employing a transparent wall 210, the air flow barrier 180 may be provided between the optical opening 120 of the housing 110 and the transparent wall 210. The air flow barrier 180 may then contribute to keeping pollutants away from the transparent wall 210, hence keeping transparent wall 210 clean and thereby transparent to light. Optionally, a transparent wall 210 may be employed in combination with upper suction means 200 as previously described. The upper suction means 200 may then be configured to extract any one or more of air, liquid, dust, sand, salt and gravel at least from between the transparent wall 210 and the optical opening 120 of the housing 110. FIGS. 5 and 6 schematically illustrate an embodiment of the disclosure where the drive-over tire tread depth gauging system 100 comprises a transparent wall 210 provided between the optical scanner 150 and the optical opening 120 of the housing 110. The transparent wall 210 may generally be sealed to the housing wall 250, hence forming a sealed of compartment in the housing 110, where said compartment houses the optical scanner 150.

The drive-over tire tread depth gauging system may according to the present disclosure comprise additional optional features. As an example the drive-over tire tread depth gauging may further comprise a liquid inlet for providing a cleaning liquid to the surface of the transparent wall facing the optical opening of the housing. The cleaning liquid may for example be a windscreen washer fluid, water, or any alcohol-based cleaning liquid. The cleaning liquid may for example be provided periodically, and optionally be removed from the transparent wall using the lower suction means.

In order to adapt the drive-over tire tread depth gauging system 100 to Nordic climates, the drive-over tire tread depth gauging system 100 may, as schematically illustrated in FIG. 6, comprise a heat source 230 configured to heat at least a part of the drive-over tire tread depth gauging system 100. A heat source 230 may be preferred if there is a need to melt snow and or ice, or to keep one or more parts of the drive-over tire tread depth gauging system 100 above a certain temperature, for example a critical temperature for condensation. The drive-over tire tread depth gauging system 100 may additionally or alternatively be provided in a tunnel. A tunnel may provide shelter for may pollutants, for example one or more of salt, sand, dust and gravel.

A particular aspect of the present disclosure provides a method for gauging the tire tread depth of a moving vehicle. The method comprising the steps of a) providing a drive-over tire tread depth gauging system according to any of the embodiments previously described, b) embedding the drive-over tire tread depth gauging system in a road or road segment such that the top opening of the housing of the drive-over tire tread depth gauging system aligns with the surface of the road or road segment, c) moving the housing lid of the drive-over tire tread depth gauging system from a closed position to an open position, d) providing a continuous air flow barrier between the optical scanner and the optical opening of the housing as long as the housing lid is in the open position, and e) measuring, by the optical scanner of the drive-over tire tread depth gauging system, the tire tread depth of the tire of the moving vehicle as the vehicle drives across the drive-over tire tread depth gauging system.

1. A drive-over tire tread depth gauging system comprising:
a housing comprising an optical opening, the housing being configured to be embedded in a road such that a tire of a vehicle is able to roll across the optical opening of the housing;
an optical scanner disposed inside the housing, the optical scanner being configured to measure, through the optical opening of the housing, a tread depth of the tire as the tire rolls across the optical opening of the housing; and
at least one air nozzle configured to provide an air flow barrier between the optical scanner and the optical opening of the housing.

2. The drive-over tire tread depth gauging system according to claim 1, where the at least one air nozzle is configured to provide an air flow from within the housing, out through the optical opening of the housing.

3. The drive-over tire tread depth gauging system according to claim 1, further comprising:
a lower suction device configured to extract one or more of air, liquid, dust, sand, salt, and gravel at least from below the air flow barrier.

4. The drive-over tire tread depth gauging system according to claim 3, further comprising:
an upper suction device configured to extract one or more of air, liquid, dust, sand, salt and gravel at least from between the air flow barrier and the optical opening of the housing.

5. The drive-over tire tread depth gauging system according to claim 4, where the upper suction device is disposed at least partly in a direct air flow path from the air nozzle.

6. The drive-over tire tread depth gauging system according to claim 1, further comprising:
a transparent wall provided between the optical scanner and the optical opening of the housing,
wherein the at least one air nozzle is configured to provide the air flow barrier between the transparent wall and the optical opening of the housing.

7. The drive-over tire tread depth gauging system according to claim 5, wherein the upper suction device is configured to extract one or more of the air, the liquid, the dust, the sand, the salt, and the gravel at least from between the transparent wall and the optical opening of the housing.

8. The drive-over tire tread depth gauging system according to claim 6, further comprising:
a liquid inlet configured to provide a cleaning liquid to a surface of the transparent wall facing the optical opening of the housing.

9. The drive-over tire tread depth gauging system according to claim 1, further comprising:
a heat source configured to heat at least a part of the drive-over tire tread depth gauging system.

10. The drive-over tire tread depth gauging system according to claim 1, wherein the at least one air nozzle comprises at least one air knife.

11. The drive-over tire tread depth gauging system according to claim 10, wherein the at least one air knife is a linear air knife disposed in or along at least one wall of the housing.

12. The drive-over tire tread depth gauging system according to claim 1, further comprising:
at least one air guide configured to guide the air flow from the at least one air nozzle.

13. The drive-over tire tread depth gauging system according to claim 1, wherein the optical scanner comprises a laser triangulation scanner.

14. A method comprising:
measuring, by the drive-over tire tread depth gauging system according to claim 1, the tread depth of the tire of the moving vehicle.

15. A method for gauging a tire tread depth of a tire of a moving vehicle, the method comprising:
providing the drive-over tire tread depth gauging system according to claim 1;
embedding the drive-over tire tread depth gauging system in a road or a road segment such that the optical opening of the housing of the drive-over tire tread depth gauging system aligns with a surface of the road or the road segment;
providing the air flow barrier between the optical scanner and the optical opening of the housing; and
measuring, by the optical scanner of the drive-over tire tread depth gauging system, the tire tread depth of the tire of the moving vehicle as the vehicle drives across the drive-over tire tread depth gauging system.

16. The method according to claim 15, further comprising:
determining that the moving vehicle is approaching the drive-over tire tread depth gauging system,
wherein the air flow barrier is provided when it is determined that the moving vehicle is approaching the drive-over tire tread depth gauging system.

17. The drive-over tire tread depth gauging system according to claim 1, wherein the at least one air nozzle is configured to provide an air flow barrier between the optical scanner and the optical opening of the housing when the tire rolls across the optical opening of the housing.

18. The drive-over tire tread depth gauging system according to claim 1, further comprising:
a suction device configured to extract one or more of air, liquid, dust, sand, salt and gravel at least from between the air flow barrier and the optical opening of the housing.
